(19) United States
(12) Patent Application Publication
(10) Pub. No.: US 2014/0262617 A1
(43) Pub. Date: Sep. 18, 2014

(54) Ladder

(71) Applicant: HAILO-WERK RUDOLF LOH GMBH & CO. KG, Haiger (DE)

(72) Inventors: Gerhard Mülller, Burback (DE); Rudolf Pfeifer, Mudersbach (DE); Gerd Weinhold, Bad Berleburg (DE); Charlos Schmidt, Haiger (DE)

(73) Assignee: HAILO-WERK RUDOLF LOH GMBH & CO. KG, Haiger (DE)

(21) Appl. No.: 13/832,016

(22) Filed: Mar. 15, 2013

(51) Int. Cl. E06C 7/42

(52) U.S. Cl. CPC E06C 7/423
USPC 182/107

(57) ABSTRACT

A free-standing ladder includes a pair of rails connected to one another by rungs or steps. A ladder foot is located on at least a first end of each rail. The ladder may be erected in such a way that it bears on the ground with a contact area of the ladder feet.

### FIELD OF THE INVENTION

The present invention relates to a ladder.

### BACKGROUND

Ladders, in particular stepladders, are generally known. Stepladders are often referred to as household ladders, thus indicating the considerable number of people who use such ladders. Many of these ladders are used domestically, for instance, when installing items on ceilings or walls, for renovating work, etc. These ladders are, however, not only used indoors. They are also used outdoors, particularly in the garden, for instance when cutting bushes, trees or hedges, or for harvesting fruit.

Whilst there is generally always a suitable area available indoors for securely erecting a ladder, this is not always the case outdoors. On overgrown garden soil, and even more so on bare garden soil, there is an ever-present risk of the ladder feet sinking as a result of the pressure bearing on them when the ladder is being used. Mostly the ladder feet at the ends of the rails do not sink into the soil simultaneously and/or to the same extent. The ladder may then rapidly assume a slanted position. Ultimately, there is the risk of the user falling from the ladder, or of the ladder falling over together with the user. This may result in injury or even worse.

In order to prevent such consequences, users of ladders often place boards or similar under the ladder feet in order to prevent the ladder from sinking. In addition, ladders are available which are made and sold by their manufacturers with a protection against sinking for preventing the ladder from sinking, in particular into soft garden soil. The principle applied to these ladders is to achieve a reduction of the ladder feet by pressure exerted on the soil by enlarging the ladder feet, and thus to prevent them from sinking.

While some ladders are provided with protection against sinking, these ladders may be used indoors only with limitations. Such ladders typically include a ladder foot mounted on the first ends of both rails that may be enlarged by means of pulling it out. But even in its retracted state, this foot has a sizeable area requirement for erecting the ladder in comparison with a conventional stepladder for indoor use. As a result of the large ladder feet, areas with only a limited available floor space may become obstacles to setting up the ladders. In addition, as a result of the large ladder feet, the ladders require a sizeable storage area when the ladder is not in use and being stored. Thus, it would be desirable to provide an indoor/outdoor ladder that overcomes these limitations.

### SUMMARY OF THE INVENTION

The present invention relates to a ladder, namely, a free-standing ladder, comprising a pair of rails, wherein the rails are connected to one another by rungs or steps, wherein a ladder foot is located on at least a first end of each rail. The ladder may be erected in such a way that it bears on the ground with a contact area of the ladder feet.

Set against the background of the disadvantages of conventional ladders, the object of the invention is to provide a ladder which is suited to use indoors and outdoors, which requires little space and is still able to afford a user a secure positioning of the ladder. This object is achieved according to the invention in that the ladder comprises a protection against sinking to prevent the ladder from sinking, in particular, into soft ground in the garden and in that the ladder comprises a strut as protection against sinking which, in a first installation position, covers the contact areas of the ladder feet and is detachably mounted on the rails. In the first installation position, the strut is mounted to the rails in addition to the feet, in order to provide a protection against sinking when used outdoors. However, when the ladder is to be used indoors or stored, the strut may be removed and the ladder placed on the ladder feet without the strut.

The strut of a ladder according to the invention may comprise a first leg and a second leg. In the first installation position, the first leg may lie against the first sides of the rails. The second leg may cover the contact areas of the ladder feet. The first leg may comprise a groove in which heads of two screws are movably located. The threads of the screws may be arranged substantially perpendicular to the strut.

The rails may comprise holes in the region of the first ends, through which holes the screws pass in the first installation position of the strut. In the first installation position of the strut, nuts, in particular wing nuts or star-grip nuts, may be screwed onto the ends of the screws protruding from the holes. The strut and the rails may be detachably connected to one another by means of the screws and the nuts.

The strut may preferably be mounted on the ladder not only in the first installation position. Far rather it is possible to also mount the strut on the ladder in a second installation position. The strut may be accommodated in this second installation position for instance when the ladder is being stored. An accommodation in the second installation position is also possible for transporting the ladder.

In the second installation position, the strut may be detachably mounted between a bracket connecting the second ends of the rails or a utility tray connecting the second ends of the rails on the one hand, and a topmost rung or step or a pivot axle of a platform of the ladder or a support brace for the platform on the other hand.

In the second installation position, the strut may be mounted in a form-fitting manner. The strut may comprise, at a first end and a second end, connecting structures which are suited to and equipped for the form-fitting connection.

In the second installation position, the strut may be mounted in a form-fitting manner exclusively or additionally to another type of mounting. Accordingly, the strut may for example be jammed between the bracket connecting the second ends of the rails or the utility tray connecting the second ends of the rails on the one hand, and the topmost rung or step or a pivot axle of the platform of the ladder or the support brace for the platform on the other hand.

The ladder according to the invention may be a leaning ladder or a free-standing ladder, in particular a stepladder. In the event of being a free-standing ladder or a stepladder, the ladder may comprise an ascending part and a supporting part which are connected to one another by articulated joints. The ascending part may comprise the rails with the rungs or steps attached thereto, with the strut being mounted to the first ends of said rails in the first installation position. In addition, the supporting part may comprise additional rails which are connected to one another by cross braces and which comprise first ends to which additional ladder feet are attached. An additional strut may be detachably mounted on the additional ladder feet as a protection against sinking in a first installation position.

The additional strut may be identical to the strut detachably mounted on the ascending part in the first installation position. The two struts may be mutually interchangeable. The additional strut may be detachably mounted in the first installation position on the additional rails and/or in a second installation position between the bracket connecting the second ends of the rails or the utility tray connecting the second ends of the rails on the one hand, and the topmost rung or step or the pivot axle of the platform or the support brace of the platform on the other hand, in the exact same manner as the strut which is detachably mounted in the first installation position on the ascending part.

### BRIEF DESCRIPTION OF THE DRAWINGS

Further characteristics of the invention are explained in the following description of an exemplary embodiment with reference to the attached figures, wherein:

FIG. 1 is a frontal view of a ladder according to the invention in a folded state and with a strut in a second installation position,

FIG. 2 is a view from above of the ladder shown in FIG. 1 in a folded state with the strut in a second installation position,

FIG. 3 is a view from below of the ladder shown in FIGS. 1 and 2 in a folded state with the strut in a second installation position,

FIG. 4 is a side view of the ladder shown in FIGS. 1 to 3 in a folded state with the strut in a second installation position,

FIG. 5 is a view from behind of the ladder shown in FIGS. 1 to 4 in a folded state with the strut in a second installation position,

FIG. 6 is a perspective frontal view of the ladder shown in FIGS. 1 to 5 in a folded state with the strut in a second installation position,

FIG. 7 is a perspective view from behind of the ladder shown in FIGS. 1 to 5 in a folded state with the strut in a second installation position,

FIG. 8 is a frontal view of the ladder according to the invention in a folded state with a strut in a first installation position,

FIG. 9 is a view from above of the ladder shown in FIGS. 1 to 8 in a folded state with the strut in a first installation position, FIG. 10 is a view from below of the ladder shown in FIGS. 1 to 9 in a folded state with the strut in a first installation position,

FIG. 11 is a side view of the ladder shown in FIGS. 1 to 10 in a folded state with the strut in a first installation position,

FIG. 12 is a view from behind of the ladder shown in FIGS. 1 to 11 in a folded state with the strut in a first installation position,

FIG. 13 is a perspective frontal view of the ladder shown in FIGS. 1 to 12 in a folded state with the strut in a first installation position,

FIG. 14 is a perspective view from behind of the ladder shown in FIGS. 1 to 13 in a folded state with the strut in a first installation position,

FIG. 15 is a side view of the ladder shown in FIGS. 1 to 14 in an erected state with the struts in the first installation position, and

FIG. 16 is a perspective view of a ladder shown in FIGS. 1 to 14 in an erected state with the struts in the first installation position.

Like reference numerals have been used to identify like elements throughout this disclosure.

### DETAILED DESCRIPTION OF THE INVENTION

The ladder according to the invention, being a stepladder, comprises an ascending part 1 and a supporting part 2. The ascending part 1 and the supporting part 2 are connected to one another by means of a joint.

The ascending part comprises two rails 11 which are connected to one another by three steps 12, a pivot axle 15, and a utility tray 14. The spacing between one step 12 and another step 12 or between the topmost step 12 and the pivot axle represents a customary measurement. Ladder feet 13 are located at the lower end of the ladder rails 11, with which ladder feet the ladder may stand on a surface. The upper ends of the rails 11 are connected to one another by means of a utility tray 14.

The supporting part also comprises two rails 21 which are connected to one another by means of the cross braces 22, 25. A first of the two cross braces 22, 25, namely the cross brace 22, is provided in the region of a lower end of the supporting part 2. An upper cross brace 25 of the two cross braces 22, 25 is located approximately at the height of the pivot axle 15 of the ascending part and is also referred to as support brace 25. The lower ends of the rails 21 also comprise ladder feet 23. Covers 24 are provided at the upper ends of the rails, which cover the joint between the rails 11 of the ascending part 1 and the rails 21 of the supporting part.

A platform 16 is pivotably located on the pivot axle 15. This platform 16 is connected to the support brace 25 by means of a bracket 26 in a known manner. The bracket 26 causes the platform 16 to fold down onto the support brace 25 when the ladder is erected. When the ladder is folded together, the bracket 26 causes the platform 16 to fold upward between the rails 11.

To this point, the ladder represents a conventional ladder as manufactured by the applicant over a considerable period of time.

The particular aspect of the ladder according to the invention lies in the struts 31 which, in the first installation position, are mounted to the lower ends of the rails 11 of the ascending part 1 and the lower ends of the rails 21 of the supporting part.

The struts 31 have a uniform profile. They comprise two legs which are arranged at an angle relative to one another corresponding, preferably, to the angle formed between a rear side of the ladder feet 13 and a lower side of the ladder feet 23. The struts each comprise a groove provided on the inner side of the legs which, in the first installation position, lie against the inner side of the rails 11, 21. Heads of screws 32 are movably guided in the grooves in the longitudinal direction of the struts 31. Two screws 32 are provided on each strut 31. The threads of the screws 32 protrude approximately perpendicularly from the strut 31.

The other legs cover the underside of the ladder feet 13, 23 in the first installation position of the strut 31.

Holes passing through the rails from front to back are provided at the lower ends of the rails 11, 21. The screws 32 pass through these holes in the first installation position of the strut 31. Star-grip nuts 33 are screwed onto the ends of the screws 32 protruding from the holes. The screws 32 and the star-grip nuts 33 detachably mount the struts 31 on the rails 11, 21. The star-grip nut 33 may be loosened manually and without a tool.

The struts 31 may be removed from their first installation position by means of loosening the star-grip nuts 33 and pulling out the screws 32 from the holes at the lower ends of the rails 11, 21. The struts 31 may then be moved to their second installation position.

As a result of the screws 32 being movably located in the grooves of the struts 31, it is possible to freely choose the spacing between the screws 32. This makes it possible to provide the struts for ladders with different spacings at the lower ends of the rails 11, 21. The spacings at the lower ends of the rails 11, 21 usually depend on the access height of a ladder. Accordingly, ladders with a greater access height usually have a greater spacing at the lower ends of the rails than ladders with a lower access height. As a result of the screws 32 being movable on the struts, it is possible to use the struts 31 for ladders with different access heights.

The struts 31 comprise caps 34 at their ends, which caps are used, among other things, for fastening in the second installation position, said caps having connecting structures with which the struts may be mounted in a form-fitting and force-fitting manner between the utility tray 14 and the support brace 25 in the second installation position. The connecting structures comprise a hollow molding into which the pivot axle 15 may engage.

The struts 31 are preferably accommodated in the second installation position for the purpose of transporting the ladder or for storing the ladder.

We claim:

1. A ladder comprising:
a pair of rails (11), wherein the rails (11) are connected to one another by rungs or steps (12); and
a ladder foot (13) located on at least a first end of each rail (11),
wherein the ladder is erected in such a way that it bears on the ground with a contact area of each ladder foot (13), and wherein the ladder further comprises a protection against sinking, the protection including a strut (31) selectively disposed in a first installation position such that the strut covers the contact area of the ladder foot (13) and is detachably mounted on the rails (11).

2. The ladder according to claim 1, wherein the strut (31) comprises a first leg and a second leg, wherein, in the first installation position, the first leg lies against first sides of the rails (11) and the second leg covers the contact areas of the ladder feet (13).

3. The ladder according to claim 2, wherein the first leg comprises a groove in which heads of two screws are movably located.

4. The ladder according to claim 3, wherein the rails comprise holes in the region of the first ends, through which holes the screws pass in the first installation position of the strut.

5. The ladder according to claim 4, wherein, in the first installation position of the strut (31), nuts (33) are screwed onto the ends of the screws (32) protruding from the holes, the strut (31) and the rails being detachably connected to one another by means of the screws (32) and the nuts (33).

6. The ladder according to claim 1, wherein, in a second installation position, the strut (31) is detachably mounted between a bracket connecting second ends of the rails (11) or a utility tray (14) connecting the second ends of the rails (11) on the one hand, and a pivot axle of a platform (16) of the ladder or a support brace (25) for the platform (16) on the other hand.

7. The ladder according to claim 6, wherein the strut (31) in the second installation position is mounted in a form-fitting manner.

8. The ladder according to claim 6, wherein the strut (31) comprises, at a first end and a second end, connecting structures which are suited to and equipped for the form-fitting connection.

9. The ladder according to claim 6, wherein the strut (31) in the second installation position is mounted in a force-fitting manner.

10. The ladder according to claim 1, wherein:
the ladder is a free-standing ladder comprising an ascending part (1) and a supporting part (2) which are connected to one another by articulated joints,
the ascending part (1) comprises the rails (11) with the rungs or steps (12) attached thereto, with the strut (31) being mounted to the first ends of the rails in the first installation position, and
the supporting part (2) comprises additional rails (21) connected to one another by cross braces (15), the additional rails comprising first ends to which additional ladder feet (13) are attached and on which an additional strut (31) is detachably mounted in a first installation position as a protection against sinking.

11. The ladder according to claim 10, wherein the additional strut (31) is identical to the strut (31) detachably mounted on the ascending part (1) in the first installation position.

12. The ladder according to claim 11, wherein the additional strut (31) is detachably mounted in the first installation position on the additional rails (21) and/or in a second installation position between the bracket connecting the second ends of the rails (11) or a utility tray (14) connecting the second ends of the rails (11) on the one hand, and the topmost rung or step or the pivot axle of the platform or the support brace (25) of the platform on the other hand, in the exact same manner as the strut (31) which is detachably mounted in the first installation position on the ascending part (1).
